(19) United States
(12) Patent Application Publication
(10) Pub. No.: US 2012/0117531 A1
(43) Pub. Date: May 10, 2012

(54) Instantiating a Software Development Environment From an Environment Class

(75) Inventors: Omer Rosenbaum, Kirkland, WA (US); Meir Shmouely, Kirkland, WA (US); Hatem Zeine, Redmond, WA (US)

(73) Assignee: Microsoft Corporation, Redmond, WA (US)

(21) Appl. No.: 12/941,531

(22) Filed: Nov. 8, 2010

(51) Int. Cl. G06F 9/44

(52) U.S. Cl. 717/100

(57) ABSTRACT

A machine-implemented method for instantiating a software development environment includes the steps of defining an environment class whereby software prerequisites are added automatically to the environment; generating at least one physical topology to which the environment class will be deployed; and deploying the environment class to generate an environment instance from said environment class. The environment class includes at least one role selected from a plurality of roles, the role encapsulating deployment information. According to some embodiments, the environment class includes at least two roles and at least one rule defining at least one dependency between a first role and at least one additional role.

### FIELD OF THE INVENTION

The invention relates to the field of software deployment, and more particularly to defining an environment class and generating a deployment of an environment instance from it.

### BACKGROUND

To maintain a competitive edge, software companies need to be highly agile while not compromising product quality. In reality, most quality issues are discovered late in the product development cycle, which tremendously multiplies costs as engineering resources get allocated to troubleshooting and debugging rather than innovation and development. This allocation of funds negatively impacts productivity and schedules and results in a lack of agility.

In the software lifecycle, one of the biggest barriers to productivity is the sheer complexity of software deployment. Deployment stands for all of the activities that make a software system available for use, such as machine allocation, operating system installation and configuration, setup of various software prerequisites and installation of the various system services. Deployment is critical not just for the obvious reason of enabling users to use the system, but also to identify quality issues that do not surface outside a fully deployed production environment. Setting up a test or development environment involves enormous efforts with a steep learning curve. It requires close familiarity with available deployment tools and processes, as well as deep knowledge of the product being deployed. Experts are often needed to deploy environments due to their high level of complexity. Experts must know numerous configuration details, including dependencies, conflicts, geographical location restrictions, and software prerequisites. The configuration details between environments in the development cycle are often inconsistent and are installed by different experts. Many of these activities are recurring as the product evolves and new versions become available or when new customer scenarios are introduced. For instance, if a new version of a particular software component is released, the entire deployment must be recreated to account for the new version.

Furthermore, it is almost impossible to transfer knowledge of how to deploy entire environments between teams while keeping consistency through all stages of development. What is therefore needed is a way to uncover quality issues as far upstream as possible and the ability to test the systems in a near-production environment.

An object-oriented approach to programming provides many advantages over traditional procedural programming approaches. For example, an object-oriented approach permits code reuse through inheritance and modularity through encapsulation. In general, objects incorporate procedures (also called “methods” or “operations”) and data (also called “attributes” or “properties”). Objects are instantiated from and described by structures known as classes or types. A class is a general abstract specification, and an object instantiated from a class is a specific concrete instance of the class. In other words, a class defines the abstract characteristics and behaviors of an object, including the object's attributes, fields, properties, methods, operations and features. As used herein, the term “class” means a template for an object or a user-defined datatype that contains the variables, properties and methods in it.

A class consists of an interface and an implementation. The interface comprises variables and function declarations, wherein the variables represent the attributes of the class, and the function declarations specify methods for manipulating those attributes as well as performing other operations. The declaration specifies the name, return class, and argument, known collectively as the signature. The implementation refers to the actual code that implements the methods specified in the interface. Objects are instantiated from an implementation type.

Object instances, instantiated from implementation classes, are used for the execution of programs. Many instances of an object can be instantiated from an implementation class during execution of a program. The creation and deletion of object instances during program execution is referred to as “object life cycle.” Object life cycle management becomes very complex in large programs because thousands of object instances are created and deleted throughout the execution of a program.

Generating and deploying an environment is a complex process involving many fine details and requiring the combined efforts of multiple subject-matter experts. The term “role” is used to refer to software service (code or data). Roles are the building blocks of an environment. Roles include, but are not limited to, services, databases, network components, and any other functional components of the environment. Functional requirements include, but are not limited to geographical location, domain, and other requirements depending on the specific application contemplated. Each role has its own unique deployment package (all the required binaries to install the role) and installation method, unique configuration steps, prerequisites (including, but not limited to operating system version, CPU architecture, .Net flavor, and others), and dependencies or conflicts with other roles. These details and nuances are the domain of expert knowledge, which sometimes requires manual steps and tweaking to install and properly configure a role. This expert knowledge might be different for different versions of the same role, which adds to the overall complexity of installing a single role. Each environment consists of multiple roles, which makes every deployment a complex, lengthy, tedious and error-prone process best left to experts.

### SUMMARY

According to one aspect of the present invention, a machine-implemented method for instantiating a software development environment includes defining an environment class, generating at least one physical representation to which the environment class will be deployed, and deploying the environment class to generate an environment instance from the environment class. Through the use of the environment class, software prerequisites are added automatically to the environment. The environment class includes at least one role encapsulating deployment information.

According to another aspect of the present invention, the environment class includes a first role, at least one additional role, and at least one rule defining at least one dependency between the first role and the additional role.

According to another aspect of the present invention, defining an environment class is achieved by selecting a first role from a pre-populated role catalog; dragging the first role to a planning board; selecting a second role from the role catalog; dragging the second role to the planning board; indicating at least one dependency between the roles; and recording the environment class to a memory device.

According to yet another aspect of the present invention, at least one property of the environment class is overridden to create the environment instance.

### BRIEF DESCRIPTION OF THE DRAWINGS

While the specification concludes with claims particularly pointing out and distinctly claiming the invention, it is believed that the embodiments will be better understood from the following description in conjunction with the accompanying figures, in which:

FIG. 1 is a schematic diagram of a logical topology of an environment class;

FIG. 2 is a schematic diagram of a physical topology of the environment class depicted in FIG. 1;

FIG. 3 depicts a method for defining an environment class according to its logical topology;

FIG. 4 depicts a method for generating a physical topology from an environment class; and

FIG. 5 illustrates an exemplary computing device that can be used to implement one or more embodiments.

### DETAILED DESCRIPTION

An “environment class” is the entity which consolidates a set of rules that define which roles are needed to form the environment, any interdependencies or conflicts, and the way they are distributed across machines, networks and geographical locations. In other words, an environment class is the logical topology of the environment. Once an environment class is defined, a live environment can be instantiated out of it in a repeatable and consistent manner, enabling users to quickly and easily deploy their own private environment instance.

In an object-oriented deployment system, environment classes hold the logical representation or logical topology of an environment, rather than the physical topology typically selected and defined by software engineers. In other words, rather than needing to define the relationships between machines and roles, the software engineer establishes the logical topology for the program which can then be adapted to multiple physical topologies while the functionality remains the same. The environment class is defined according to the logical topology of the environment. The separation of the logical topology from the physical topology provides many benefits, including consistency and scalability across varying physical topologies. In other words, the environment instance for development, the environment instance for production, and the environment instance for testing created from the same environment class will have the same logical topology and function, but can have differing physical topologies using differing numbers of machines.

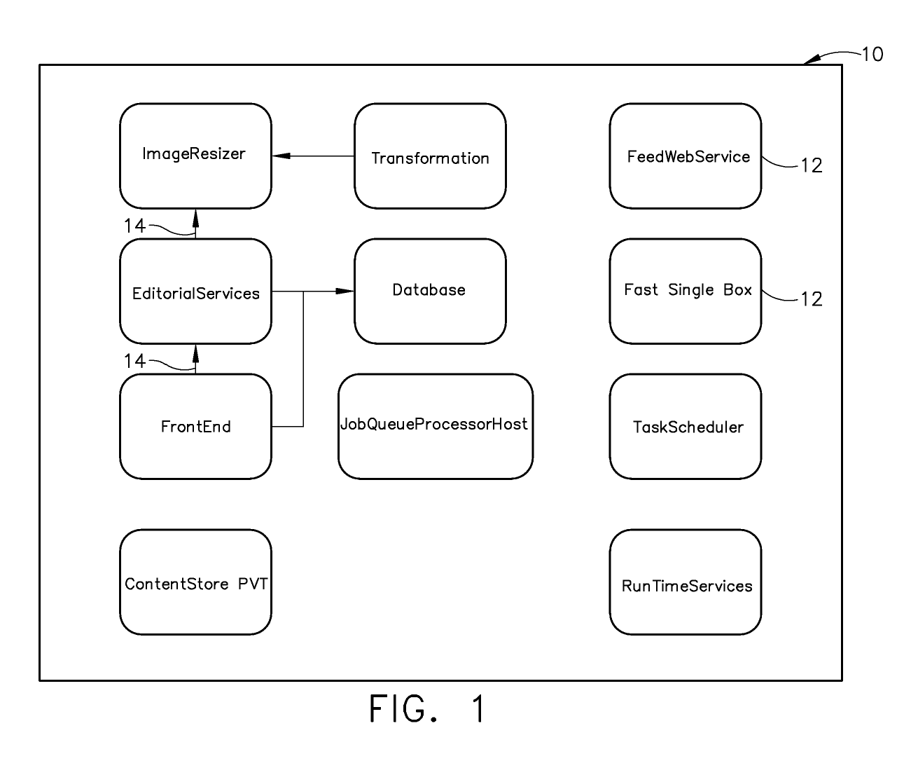

FIG. 1 depicts an example embodiment of a logical topology of an environment class. The logical topology describes the functionality, or the “how” instead of the “what.” Each environment class 10 is a set of rules that defines which roles 12 are needed for the environment, and each role 12 is an object. Each role 12 is encapsulated, meaning that each role includes all the information needed for its deployment, as well as pre-requisites and dependencies 14. Each role 12 also implements deployment operations including but not limited to install, uninstall, and verify installation. Furthermore, roles 12 can derive properties and functionality from base roles. For example, when there are many versions of the same role 12 and each requires some minor modifications, the inheritance of properties and functionalities simplifies the generation of new versions. Roles 12 can also change key properties during instantiation. This enables the instantiation of different physical topologies, modified to address user needs, while keeping the same logical topology. Although FIG. 1 depicts a logical topology including several roles 12, it is also contemplated that the logical topology can be “empty,” or include no roles at all.

In some embodiments, the user can select a multiplier number for each role 12 in the environment class 10. In such embodiments, role replication enables the user to easily replicate the role 12 automatically in the environment, reducing or even eliminating the need for the user to identify the role 12 in the environment multiple times. For example, if the developer has a service which needs to be load balanced, he can mark the role 12 to be replicated N times in the environment. In some embodiments, N can be a specific number (such as 5 or 10) while in alternative embodiments, the number can be left open, meaning that the number of replications is determined according to a rule. Other benefits of role replication will be apparent to one skilled in the art.

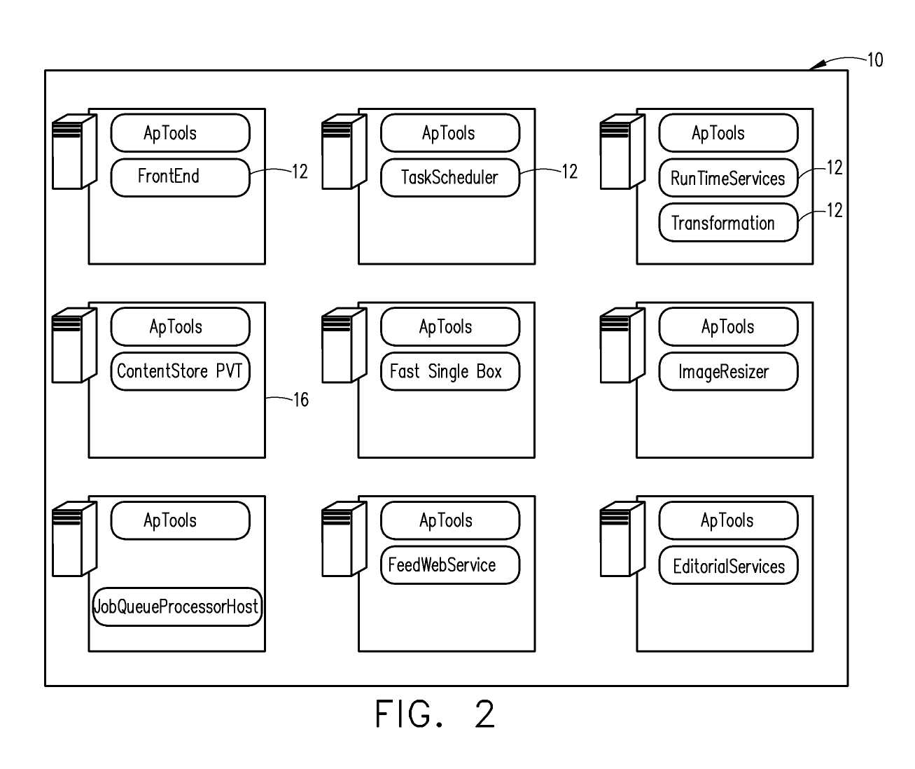

FIG. 2 demonstrates a physical topology of the environment class 10 depicted as a logical topology in FIG. 1. FIG. 2 represents one of many possible physical topologies that can be generated from the logical topology of the environment class 10. The physical topology describes the relationships between machines 16 (sometimes referred to as servers) and roles 12 and whether a role is scalable (e.g., to a cluster behind a VIP). The physical topology also resolves role dependencies and conflicts, such as which roles 12 cannot co-locate on the same machine 16, and defines networking constraints, such as geographical locations and domains. Because environment classes define the logical topology of the environment, they can be associated with multiple physical topologies, allowing for the balance of deployment costs with actual needs. For instance, a developer might only need a single box installation for pre check-in validation, whereas a tester that needs to test product scale and performance might need full-fledged deployment on many machines. In the embodiment shown in FIG. 2, each role 12 from FIG. 1 is located on its own machine 16, except for the roles 12 identified as “RunTimeServices” 12 and “Transformation” 12 which share a single machine 16. However, in an alternative physical topology of the environment class 10, roles “RunTimeServices” 12 and “Transformation” 12 can be located on separate machines, either alone or with another role 12, such as “TaskScheduler” 12. It is to be understood that the specific role names used herein are merely exemplary, and the specific roles selected and used will depend on the specific application contemplated. The possible combinations of various roles on a machine depend on the rules, conflicts and dependencies identified in the logical topology of the environment. In some embodiments, generation of the physical topologies can be manual while in other embodiments, generation of the physical topologies can be automatically derived from the user's high level needs of the deployment.

In embodiments in which physical topologies are automatically created at instantiation time, machine learning algorithms can be used along with resource availability, the expected usage metrics of each role 12, and role dependencies to optimally allocate the roles 12 to machines 16 in a way that would maximize resource usage while keeping the best performance and most efficient cost. Automatic creation of physical topologies also increases machine utilization by optimizing hardware resource use of each host machine, increases the general reliability of roles by automatically striping them smartly across the environment, and increases the overall system performance by optimizing the physical locations of interdependent roles thereby reducing latencies, saving time, and simplifying optimization despite complexity.

Since environment classes hold the logical topology of the environment, different users can instantiate different instances, with different versions of the same roles. In some embodiments, the logical topology includes the number of instances of each role, referred to as a cluster. For example, the same environment class can be used to instantiate the current production version or a newer version that is under development. This simplifies the complexity of managing environments and enables the same developer to easily reproduce a production environment or a development environment with the latest build using the exact same steps. Furthermore, an environment class can include roles that are identified by rules or left open, rather than by specific version numbers. For example, an environment class can include a role of which the most recent version is to be used. In such cases, when the environment class is instantiated, the most recent version of that role in the cluster will be installed on the machines, eliminating the need for the engineer to make a determination as to which version is the most recent version each time he deploys the environment. In this way, the environment can be tested using the latest versions of software, even when the engineer is not aware that a new version was released. Similarly, version ranges can be identified in the environment class, such that when an instance is created, only certain versions of a role can be used.

When roles are left open, the engineer can also override this property, and specify a specific version of the role to be used in an environment instance. For example, if the engineer is trying to recreate an environment used previously to locate a problem or to test compatibility, the engineer can select the specific version of the role that he wishes to install. In some embodiments, properties of the environment class can be overridden even if not left open. In such embodiments, the engineer uses the environment class as a template, saving him the time and energy ordinarily required to recreate large parts of an environment when only a small portion of an already existing environment class requires modification. Other properties of the environment class or specific roles therein can be overridden, depending on the specific application contemplated and the specific needs of the user.

The use of environment classes enables an operations engineer to utilize the benefits described above to create pre-production environments for testing. In production, it is common to find the same functional environments configured differently across different datacenters which complicates manageability and hot fixes. This is primarily because different people are involved in the deployment process, different processes are used, and because historical deployments are sometimes kept untouched. Using an environment class with one logical topology results in consistency across the entire development process as well as in production deployments across datacenters.

In some embodiments, the environment class contains zero (0) roles, and the logical topology is referred to as an “empty logical topology.” An environment class with an empty logical topology is useful during the development process since a developer can have an iterative way of working. For example, the developer can create an environment instance from an environment class with no roles, manually work with the machines and learn how to best create his role, release the instance, create a new instance with that role, and manually work with the machines to learn how to best create his next role. In such embodiments, the default physical topology includes a defined number of servers. For example, one physical topology for an environment class with an empty logical topology includes five servers. The user can then add or remove servers as needed during the development process. The specific number of servers varies depending on the specific application contemplated.

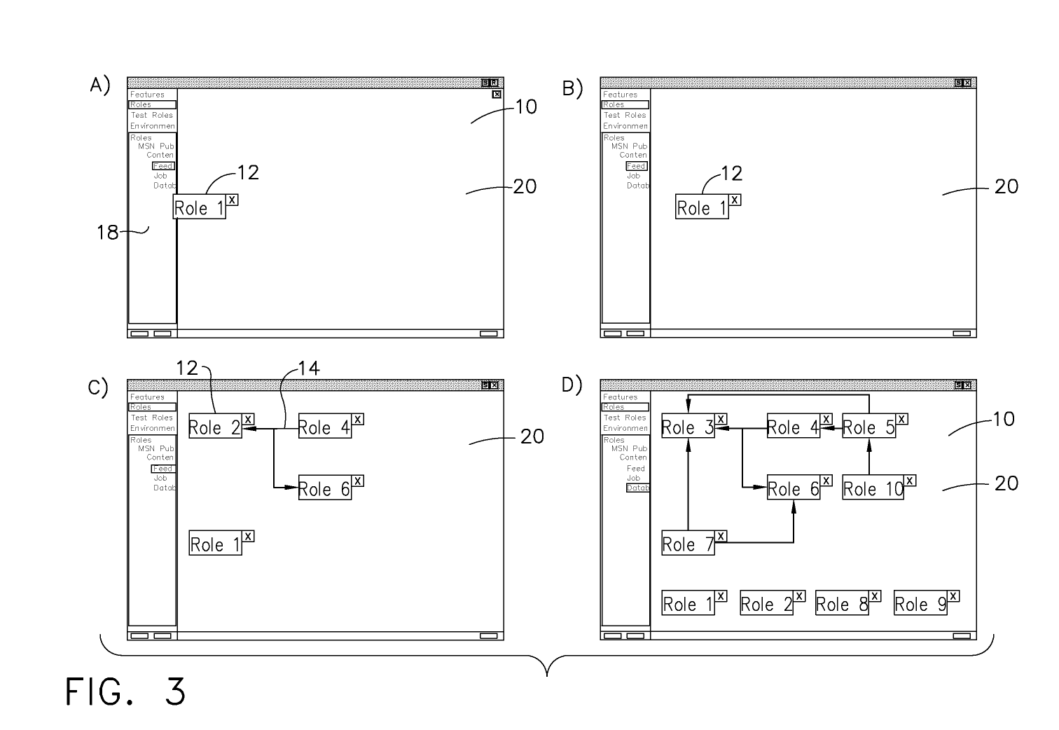

FIG. 3 shows an exemplary method for defining an environment class. As shown in FIG. 3A, an environment class 10 is generated or defined by selecting environment roles from a catalog 18 of roles 12. The catalog 18 is depicted as a list in a pane in which each role 12 is an item in the list in FIG. 3A. Roles can be added, removed, and edited from the role catalog as needed. For example, if a developer or tester needs a role that is not in the catalog, he can create the role and add it to the role catalog for easy access in the future. In other embodiments, the developer can edit an existing role to achieve the desired role. In the embodiment shown in FIG. 3, the roles are placed on a “planning board” 20 using a drag and drop feature, although other methods of selecting and organizing the roles can be used depending on the specific application contemplated. FIG. 3A depicts the role 12 being selected by the user and FIG. 3B depicts the role 12 being dropped onto the planning board 20. In FIG. 3C, dependent roles and software prerequisites are automatically added, based on the role 12 selected. Automatic addition of required dependent roles and software prerequisites is achieved because of the information encapsulated in the role 12. Also encapsulated in each role 12 is deployment information specific to that role 12. The next role 12 is selected and added to the planning board 20. Dependency lines 14 are added, representing the rules that define the interdependencies between multiple roles 12. Once all the roles 12 are placed on the planning board 20, the logical topology of the environment class 10 is ready, as shown in FIG. 3D. In some embodiments, the environment class 10 is saved to a memory device, enabling the environment class to be accessed at a later point in time. In other words, the environment class 10 can be re-used for other deployments and in other stages of development.

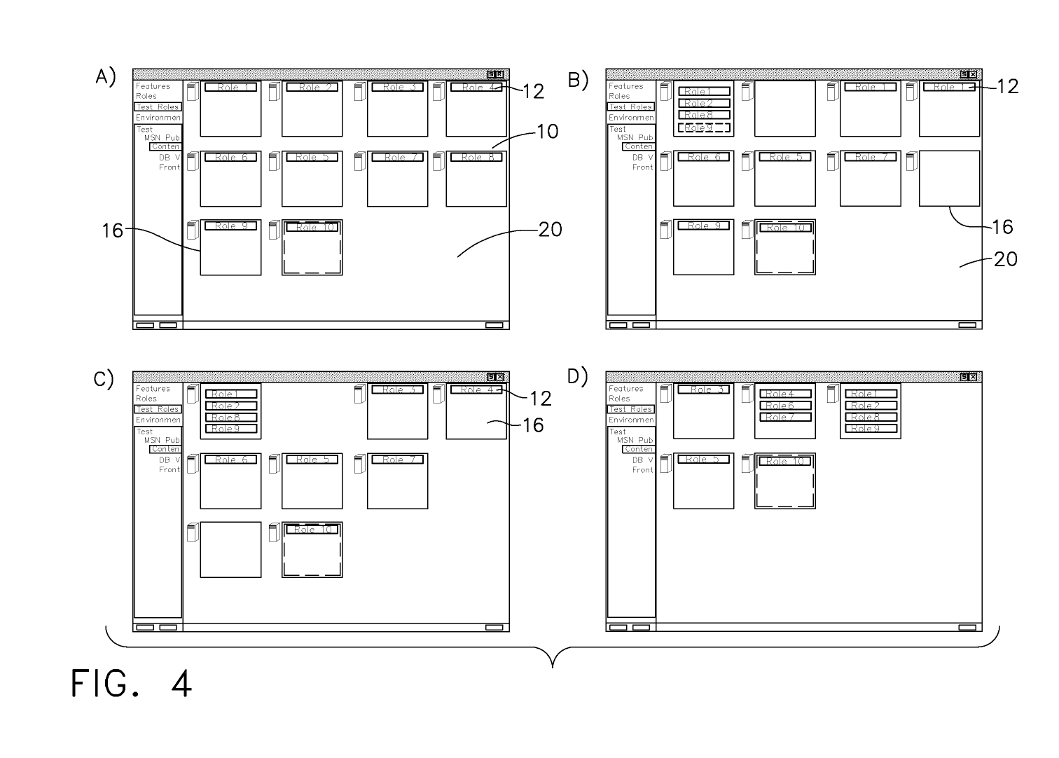

The next step in creating an environment instance from an environment class is to generate the physical topology to which the environment class will be deployed. In some embodiments, a series of physical topologies to which the environment class will be deployed is created. The generation of a physical topology is shown in FIG. 4. When the user is ready to create the physical topology of the environment from the environment class, the user selects the environment class for which he wishes to generate the physical topology. In some embodiments, the user selects the environment class from a catalog of environment classes that have been recorded to a memory device. In other embodiments, such as when the user has just defined the environment class, the environment class for which the physical topology is to be generated is pre-selected and loaded to the system.

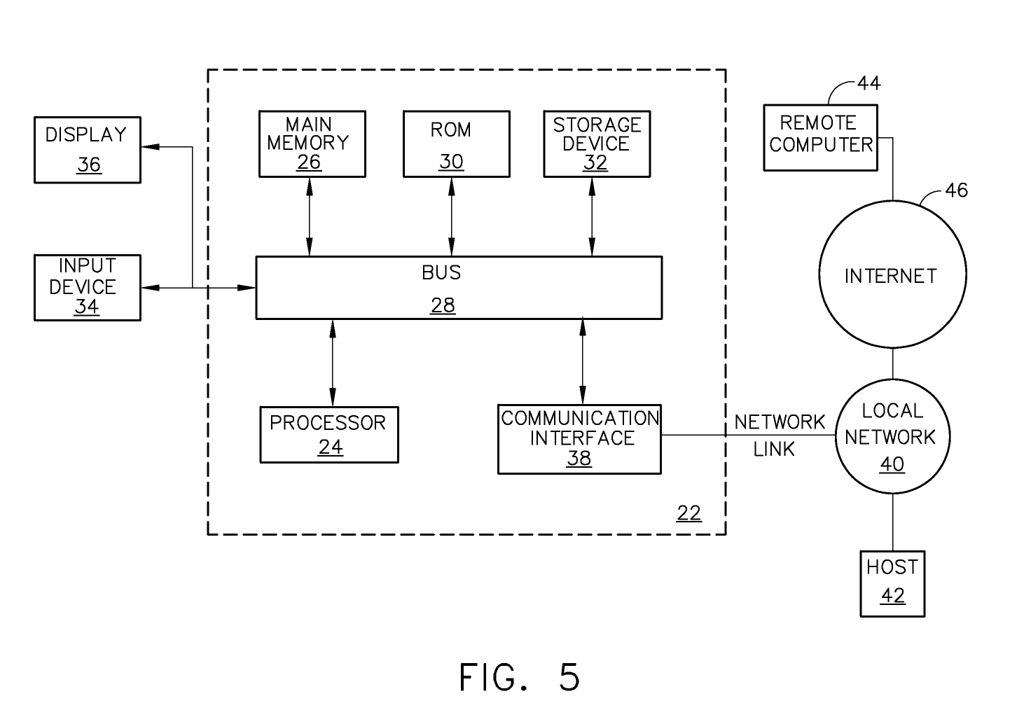

In some embodiments, the generation of a physical topology is conducted automatically or at least partially automatically. The automatic generation of a physical topology can be achieved through the use of an algorithm executed on a machine. The algorithm can be configured to allocate each role to one of a plurality of machines according to the number of machines available, expected usage metrics of each role, and dependencies and conflicts identified between roles. The expected usage metrics of each role are encapsulated with each role, along with the deployment and other information. Dependencies and conflicts indicate to the system which roles should be located on the same machine 16 and which roles cannot be co-located. In some embodiments, machine 16 is a physical box or hardware, such as is described in accordance with FIG. 5 hereinbelow. In other embodiments, however, machine 16 need not be a physical box but is a software emulation of a computer within a host computer. For example, machine 16 can be a virtual machine running on a hypervisor.

As shown in FIG. 4A, the system automatically selects the number of machines 16 according to the number of roles 12 in the environment class 10 and allocates one role 12 to one machine 16. In other words, the default physical topology is one role 12 to one machine 16. In alternative embodiments, the user selects from the beginning the number of machines 16 to be used and indicates this to the system. The system then generates a physical topology by allocating the roles to this indicated number of machines 16. In some embodiments, the physical topology generated by the automatic allocation of roles is the topology desired by the user or is deemed suitable, and the physical topology is saved for use in deployment. In other embodiments, however, the user can re-allocate roles 12 and modify the physical topology.

As shown in FIG. 4B, in embodiments in which the user wants or needs to modify the physical topology, the roles 12 can be re-allocated by dragging the icon representing the role 12 from one machine 16 to another machine 16 on the planning board 20. As in the process of defining the environment class, the re-allocation can be achieved by means other than dragging and dropping and through the use of a planning board, depending on the specific application contemplated. Depending on the re-allocation of roles 12 by the user, some machines 16 will be left without any roles 12. In FIG. 4C, these machines 16 are removed from the physical topology. Removal of a machine can be achieved by clicking a “Remove” or “Delete” button present on the screen, right-clicking the machine 16 icon and selecting “Remove” or “Delete,” or another means depending on the specific application contemplated. In FIG. 4D, after the removal of unused machines 16, the remaining machines 16 that have been allocated roles 12 can be reorganized to produce a neat, finalized physical topology of the environment. In some embodiments, the physical topology is recorded to a memory device, where it can be accessed at another time and/or by another user.

After the environment class has been used to generate a physical topology of the environment, the next step in deploying an environment instance is provisioning the machines to be used. Provisioning refers to operations needed to enable the machines to be used in a particular way within the environment. Provisioning the machines includes, but is not limited to, configuring servers and other consumable resources, such as storage space, central processing unit (CPU) usage, and connection bandwidth. In addition to provisioning the machines, prerequisites encapsulated by the roles are installed, and the roles themselves are installed on the appropriate machines. Finally, the environment is tested. If the environment fails one or more tests, it is retained for further investigation and debugging. Otherwise, the environment could be automatically archived and its resources are returned to the pool. The pool can include pre-provisioned servers, environment instances, pre-configured servers (servers including the operating system and installed prerequisites), scarce networking resources including machines with specific security setting configurations, IP ranges, software serial or activation keys, licenses, and any other resources that require either human intervention to create or need to be counted. The use of a resource pool is optional, and enables performance improvement and a faster response time when resources need to be reclaimed by the user.

The result of the completion of the deployment process is an environment instance. Within the environment instance, users can perform post-deployment, configuration and debugging actions, including, but not limited to, re-installing specific machines or roles, saving snapshots of the environment, zooming into server sessions of live machines in the environment, and other interactions with the machines.

Exemplary Computing System

FIG. 5 shows an exemplary computer system 22 having components that can be used to implement one or more of the embodiments described above. For example, machine 16 as described above can be computer system 22. Computer system 22 includes one or more processing units 24, a main memory 26, and a bus 28 that couples various system components including main memory 26 to processors 24. The bus 28 represents one or more of any of several types of bus structures, including a memory bus or memory controller, a peripheral bus, an accelerated graphics port, and a processor or local bus using any of a variety of bus structures. The main memory 26 can be random access memory (RAM) or another dynamic storage device coupled to bus 28 for storing information and instructions to be executed by the processor 24. Main memory 26 can also be used for storing temporary variables or other intermediate information during execution of instructions by the processor 24. The computer system 22 also includes read only memory (ROM) 30.

Computer system 22 further includes one or more storage devices 32. Storage device 32 can include a hard disk drive for reading from and writing to a hard disk, a magnetic disk drive for reading from and writing to a removable magnetic disk, and an optical disk drive for reading from or writing to a removable optical disk such as a CD or other optical media. The storage device, whether a hard disk drive, a magnetic disk drive, an optical disk drive, or a combination thereof, is connected to the bus 28 by an appropriate interface. The drives and their associated computer-readable media provide nonvolatile storage of computer-readable instructions, data structures, program modules and other data for computer system 22. Although the exemplary embodiment described herein refers to a hard disk, a removable magnetic disk, and a removable optical disk, it should be appreciated by those skilled in the art that other types of computer-readable media which can store data that is accessible by a computer, such as magnetic cassettes, flash memory cards, digital video disks, random access memories (RAMs), read only memories (ROMs), and the like, can also be used in the exemplary operating environment.

A number of program modules can be stored on the storage device 32, RAM, and ROM, including an operating system, one or more application programs, other program modules, and program data. A user can enter commands and information into the computer system 22 through input devices 34 such as a keyboard or a pointing device. Other input devices 34 can include a microphone, joystick, game pad, satellite dish, scanner, or the like. These and other input devices 34 are connected to the processor 24 through an interface that is coupled to the bus 28. A monitor or other type of display 36 is also connected to the bus 28 via an interface. In addition to the monitor, personal computers typically include other peripheral output devices such as speakers and printers.

Computer system 22 also includes a communication interface 38 coupled to bus 28. Communication interface 38 provides a two-way data communication coupling to a network link that is connected to a local network 40. Communication interface 38 can be an integrated services digital network (ISDN) card or a modem to provide a data communication connection to a corresponding type of telephone line or a local area network (LAN) card to provide a data communication connection to a compatible LAN. Wireless links can also be used, depending on the specific application contemplated. In any such implementation, communication interface 38 sends and receives electrical, electromagnetic or optical signals that carry digital data streams representing various types of information.

Computer system 22 commonly operates in a networked environment using local connections to one or more remote computers, such as host 42 or remote computer 44. The remote computer 44 can be another personal computer, a server, a router, a network PC, a peer device or other common network node, and typically includes many or all of the elements described above relative to computer system 22. In the embodiment shown in FIG. 5, the network link provides a connection through local network 40 to the host 42 or to remote computer 44 via the internet 46.

Generally, the data processors of computer system 22 are programmed by means of instructions stored at different times in the various computer-readable storage media of the computer. At execution, programs are loaded at least partially into the computer's primary electronic memory from the computer's secondary memory where they are stored. The invention described herein includes these and other various types of computer-readable storage media when such media contain instructions or programs for implementing the steps described in conjunction with a microprocessor or other data processor.

While various embodiments of the present invention have been described above, it should be understood that they have been presented by way of example, and not limitation. It will be apparent to persons skilled in the relevant art(s) that various changes in form and detail can be made therein without departing from the scope of the present invention. Thus, embodiments of the present invention should not be limited by any of the above-described exemplary embodiments, but should be defined only in accordance with the following claims and their equivalents.

What is claimed is:

1. A machine-implemented method for instantiating a software development environment comprising the steps of:
a. defining an environment class according to a logical topology whereby software prerequisites are added automatically to the environment, the environment class comprising at least one role selected from a plurality of roles, the role encapsulating deployment information;
b. generating at least one physical topology to which the environment class will be deployed; and
c. deploying the environment class to generate an environment instance from the environment class.

2. The method of claim 1, the role selected being a first role, wherein the environment class further comprises:
a. at least one additional role; and
b. at least one rule defining at least one interdependency between the first role and the at least one additional role.

3. The machine-implemented method of claim 1 wherein the step of defining an environment class further comprises the steps of
a. selecting at least one role from a pre-populated role catalog;
b. dragging the at least one role to a planning board; and
c. recording the environment class to a memory device.

4. The machine-implemented method of claim 3 wherein the environment class comprises a first role and at least one additional role, the step of defining an environment class further comprising the step of indicating at least one dependency between the first role and the at least one additional role.

5. The machine-implemented method of claim 3, the step of generating a physical topology further comprising the steps of:
a. accessing the environment class recorded on the memory device;
b. selecting a number of machines to be used; and
c. associating each selected role with a corresponding machine.

6. The machine implemented method of claim 5, further comprising the step of repeating one or more of the steps until the environment class is deployed to a predetermined number of physical topologies.

7. The machine-implemented method of claim 2, wherein the step of generating a physical topology includes generating a series of physical topologies to which the environment class will be deployed.

8. The machine-implemented method of claim 2 further comprising the steps of:
a. provisioning one or more machines to which the environment class will be deployed;
b. installing each role onto the provisioned machines; and
c. testing the environment instance.

9. The machine-implemented method of claim 1 wherein the step of generating a physical topology is conducted by a user assigning the at least one role to one of a plurality of machines.

10. The machine-implemented method of claim 5 wherein the step of generating a physical topology is conducted by an algorithm executed on a computer, the algorithm being configured to allocate each role to one of a plurality of machines according to at least one of the number of machines available, expected usage metrics of each role, and interdependencies between the roles.

11. The machine-implemented method of claim 1, further comprising the step of:
a. overriding at least one property defined by the environment class.

12. The machine-implemented method of claim 11 wherein the step of overriding at least one property comprises selecting a version of at least one role that differs from a version of the role defined by the environment class.

13. The machine-implemented method of claim 1 wherein the role is selected from the group consisting of services, databases, network components and any other logical functional unit.

14. The machine-implemented method of claim 1 further comprising the steps of:
a. provisioning one or more machines to which the environment class will be deployed;
b. installing each role onto the provisioned machines; and
c. testing the environment instance.

15. The machine-implemented method of claim 4, the step of generating a physical topology further comprising the steps of
a. accessing the environment class recorded on the memory device;
b. selecting a number of machines to be used; and
c. associating each role with a corresponding machine.

16. The machine-implemented method of claim 15 wherein the step of generating a physical topology is conducted by an algorithm executed on a computer, the algorithm being configured to allocate each role to one of a plurality of machines according to at least one of the number of machines available, expected usage metrics of each role, and the dependencies between the roles.
